(19) United States
(12) Patent Application Publication
(10) Pub. No.: US 2008/0023531 A1
(43) Pub. Date: Jan. 31, 2008

(54) Weldment and a process using dual weld wires for welding nickel -based superalloys

(76) Inventors: Jon C. Schaeffer, Greenville, SC (US); Jeffrey R. Thyssen, Delmar, NY (US); Ariel C. Jacala, Simpsonville, SC (US); Doyle C. Lewis, Greer, SC (US); Thaddeus J. Strusinski, Shelby, SC (US); Eugene Clemens, Brownsburg, IN (US); Paul A. Wilson, Houston, TX (US); Michael Butler, Seabrook, TX (US)

Correspondence Address: NIXON & VANDERHYE, PC, 901 NORTH GLEBE ROAD, 11TH FLOOR, ARLINGTON, VA, 22203, US

(21) Appl. No.: 11/493,019

(22) Filed: Jul. 26, 2006

(51) Int. Cl. B23K 31/02

(52) U.S. Cl. 228/225

(57) ABSTRACT

The welding process includes in a single pass heating and melting a filler wire of gamma-prime strengthened nickel-based superalloy along a major portion of the weld followed by a weld using a solid solution strengthened nickel-based superalloy for the remaining portion of the weld pass. Both filler materials are particularly useful for welding a single crystal gamma-prime strengthened nickel-based superalloy based metals.

### BACKGROUND OF THE INVENTION

The present invention relates to weldments and welding methods for welding gamma-prime strengthened nickel-based superalloy base materials and particularly relates to weldments and methods of welding gamma-prime strengthened nickel-based superalloy base materials to preclude or minimize solidification shrinkage, hot tears and cracking during the welding process.

Nickel-based superalloys are typically used in high temperature environments such as gas turbine components exposed to the hot gases of combustion. These superalloys have many properties making them highly desirable for use as the base material in these components. However, these highly desirable attributes have rendered nickel-base superalloys, for example, single crystal gamma-prime strengthened nickel-based superalloys difficult to weld. Ideally the optimum weld is performed with an precipitation strengthened nickel-based superalloy filler wire similar to the base material. These highly alloyed materials, however, are prone to solidification shrinkage, hot tears and cracking during the welding process. Strain age cracking also occurs due to gamma-prime precipitation when the component is post weld vacuum heat treated. The termination of each weldment and the characteristics of the nickel-based superalloy base metal and filler wire used during welding render the minimization or avoidance of strain age cracking, solidification shrinkage and hot tears problematical. Accordingly, there is a need for an effective weldment and a welding process for use in connection with precipitation strengthened nickel-based superalloys forming turbine components subjected to high temperatures.

### BRIEF DESCRIPTION OF THE INVENTION

In accordance with a preferred embodiment of the present invention, there is provided a process for welding an article comprised of a gamma-prime precipitation-strengthened, preferably single crystal, nickel-based superalloy base metal including the steps of: (a) welding the article along a major portion of a weld area using a gamma-prime strengthened nickel-based superalloy; and (b) completing the weld using a solid solution strengthened nickel-based superalloy at the termination of the welding of step (a).

In accordance with a further preferred embodiment of the present invention, there is provided a weldment for an article formed of a single crystal gamma-prime precipitation strengthened nickel-based superalloy weldment material comprising a gamma-prime strengthened nickel-based superalloy weldment filler material extending along a major portion of the weldment and a termination weldment completing the weldment with a solid solution strengthened nickel-based superalloy.

### BRIEF DESCRIPTION OF THE DRAWINGS

FIG. 1 is a fragmentary plan view illustrating an opening or crack in a base metal preferably a component of a turbine and which opening or crack is to be filled with weld material;

FIG. 2 is an enlarged fragmentary cross sectional view thereof taken about on line 2-2 of FIG. 1;

FIG. 3 is an enlarged perspective view illustrating a first filler wire and a torch for welding the opening or crack along a major portion of its length;

FIG. 4 is a view similar to FIG. 3 illustrating a second filler wire and a torch for completing the weld of the opening or crack; and

FIG. 5 is a fragmentary perspective view of a completed weld.

### DETAILED DESCRIPTION OF THE INVENTION

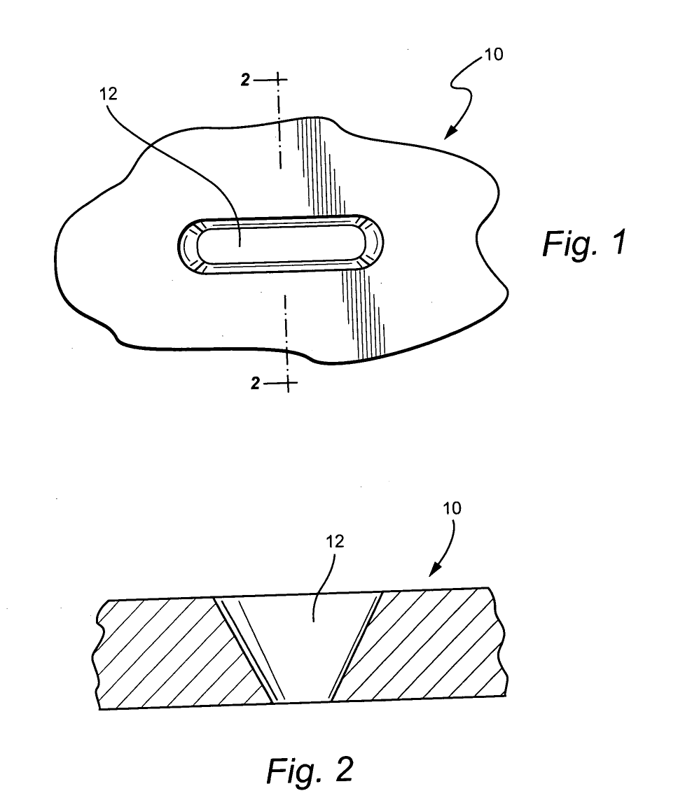

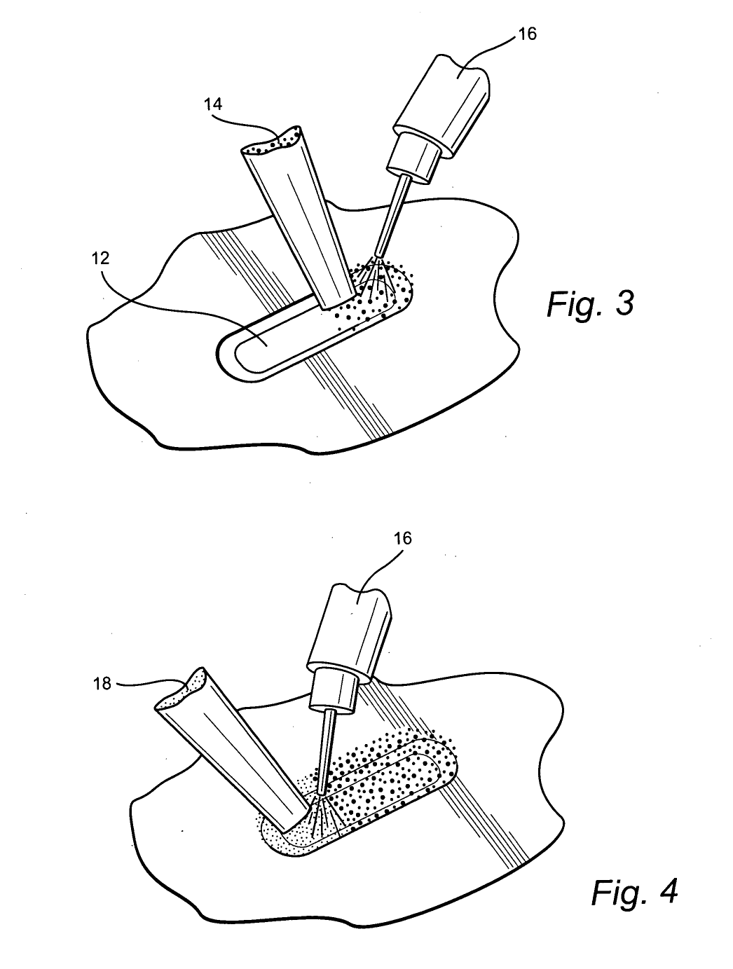

Referring now to the drawings, particularly to FIGS. 1 and 2, there is provided a metal part, for example, a gas turbine component generally designated 10 having a through opening 12 or a crack to be filled with weld material. In the weldment and method of welding according to a preferred embodiment of the present invention, the base material of the turbine component is formed of a single crystal gamma-prime strengthened nickel-based superalloy, although the base material may comprise a directionally solidified or equiaxed gamma-prime strengthened nickel-based superalloy. As noted previously, optimum welding is preferably performed with an precipitation strengthened nickel-based superalloy filler wire. However, such highly alloyed materials are prone to solidification shrinkage, hot tears and cracking during the welding process. Also, strain age cracking due to gamma-prime precipitation occurs when the component is post weld vacuum heat treated. The preferred embodiment of the present invention provides an extra measure of robustness to the weld particularly useful with single crystal gas turbine components. The bulk or major portion of the weld is performed using a precipitation strengthened nickel-based superalloy filler wire and the remaining portion of the weld is performed using a solid solution strengthened nickel-based superalloy filler wire. By completing the weld, using the solid solution strengthened nickel-based superalloy filler wire, the weld has increased ductility and a lack of susceptibility to solidification cracking, hot tearing and strain age cracking as compared with gamma-prime strength superalloys. Thus, in accordance with the preferred embodiment of the present invention, a major portion of the weld is completed using a first filler wire comprised of a gamma-prime strengthened nickel-based superalloy with the remaining portion of the weld terminating in a weld material from a second filler wire comprised of a solid solution strengthened nickel-based superalloy.

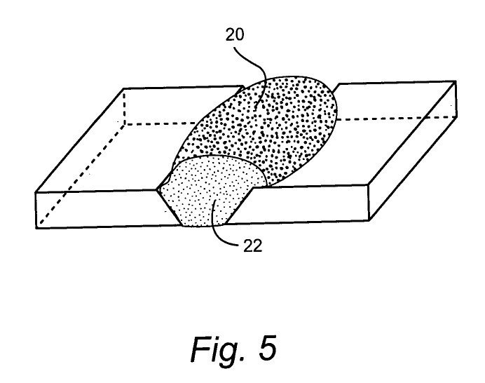

Referring now to drawing FIGS. 3 and 4, an example of a preferred welding process is illustrated. In FIG. 3, the crack or opening 12 is illustrated and will be filled with weld material preferably by sequentially melting a pair of filler wires of different materials in the same pass along the crack or opening. For example, a first filler wire comprised of a gamma-prime strengthened nickel-based superalloy is heated and melted by a torch 16 as the filler wire and torch are moved along the weld area of the crack or opening. When a major portion of the crack or opening has been filled with weld material from the first filler wire, a second filler wire 18 illustrated in FIG. 4 is substituted for the first filler wire. The remaining portion of the crack or opening is thus filled with material from the second filler wire until the weld is complete. That is, the second filler wire is substituted for the first filler wire on the fly in a continuation of the first pass of the weld materials along the length of the crack or opening. It will be appreciated that only a single pass is necessary to complete the weld in accordance with the preferred embodiment hereof. However, multiple passes using the same technique, i.e., sequentially applying filler wires of different compositions in each pass may be performed. In FIG. 4, the resulting weld is illustrated. Particularly, the bulk of the weld, i.e., the major portion of the weld, e.g., 70-80% of the length of the weld may be formed using the first filler wire 14 comprised of the gamma-prime strengthened nickel-based superalloy. The termination portion 22 of the weld at the end of the pass in FIG. 5 is comprised of the solid solution strengthened nickel-based superalloy.

The welding process is preferably carried forward in an inert atmosphere such as under an argon gaseous atmosphere. However, the process can be completed under an ambient atmosphere. Also, the base material is preferably preheated, e.g., using quartz lamps. However, it will be appreciated that preheating is not necessary, but preferred.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A process for welding an article comprised of a gamma-prime strengthened nickel-based superalloy base metal comprising the steps of:
(a) welding the article along a major portion of a weld area using a gamma-prime strengthened nickel-based superalloy; and
(b) completing the weld using a solid solution strengthened nickel-based superalloy at the termination of the welding of step (a).

2. A process according to claim 1 wherein step (a) includes heating a filler wire formed of the gamma-prime precipitation strengthened nickel-based superalloy.

3. A process according to claim 1 wherein step (b) includes heating a filler wire formed of the solid solution strengthened nickel-based superalloy.

4. A process according to claim 1 wherein the article is a component of a gas turbine.

5. A method according to claim 1 including providing a base metal of single crystal gamma-prime strengthened nickel-based superalloy.

6. A method according to claim 1 including providing a base metal of equiaxed gamma-prime strengthened nickel-based superalloy.

7. A method according to claim 1 including providing a base metal of directionally solidified gamma-prime strengthened nickel-based superalloy.

8. A method according to claim 1 wherein step (a) is performed by a first filler wire formed of the gamma-prime strengthened nickel-based superalloy along a major portion of the weld area and terminating short of a complete pass along the weld area.

9. A method according to claim 8 wherein step (b) is performed by passing a second filler wire formed of the solid solution strengthened nickel-based supperalloy along a remaining portion of the weld area to complete the weld pass along the weld area.

10. A method according to claim 9 including substituting the second filler wire for the first filler wire in the course of welding the weld area in a single pass.

11. A weldment for an article formed of a single crystal gamma-prime precipitation strengthened nickel-based superalloy base material comprising a gamma-prime strengthened nickel-based superalloy weldment filler material extending along a major portion of the weldment and a termination weldment completing the weldment with a solid solution strengthened nickel-based superalloy.
